(19) United States
(12) Patent Application Publication
(10) Pub. No.: US 2016/0325929 A1
(43) Pub. Date: Nov. 10, 2016

(54) Bag

(71) Applicant: Robert Owan Abang, JR., Cleveland, OH (US)

(72) Inventor: Robert Owan Abang, JR., Cleveland, OH (US)

(21) Appl. No.: 14/732,599

(22) Filed: Jun. 5, 2015

Related U.S. Application Data
(60) Provisional application No. 62/157,675, filed on May 6, 2015.

(51) Int. Cl. B65F 1/00

(52) U.S. Cl. CPC B65F 1/002

(57) ABSTRACT

The current invention relates to bags used for bagging groceries, trash collection, shopping, packaging products, recycling and more. The bag having an inside surface, an outside surface, a closed bottom end, and an open top end with a circumferential rim defining a mouth. Present at, at least the circumferential top portion of the bag are elastic member(s) that contract and stretch, are tacky or non-slip with frictional gripping properties present and used to allow the expansion of the bag open end. The elastic member(s) may then relax thereby providing a gripping force securing the bag to the trash receptacle. In one embodiment, the top portions of the sidewalls and/or bag body slant inward towards each other, making the top portion of the bag body, the open top end, and circumferential rim of the bag smaller in circumference and/or diameter, than the bag body and/or bottom end of the bag.

### CROSS-REFERENCE TO RELATED APPLICATIONS

This application claims the benefit of U.S. Provisional Patent Application No. 62157675 filed May 06, 2015 by Robert Owan Abang jr, and incorporated in its entirety herein by reference.

### TECHNICAL FIELD OF THE INVENTION

The present invention relates to features of bags used for various purposes including bagging groceries, shopping, packaging products, trash collection, recycling and more, preferably made from but not limited to forms of polymer, thermoplastic, plastic, polyvinyl, vinyl, polyethylene, ethylene, rubber, paper, a combination of, and/or other similar or suitable materials.

### BACKGROUND OF THE INVENTION

The present invention relates to the improvement of disposable bags used for various purposes—including bagging groceries, shopping, packaging products, and lining trash receptacles such as wastebaskets, recycling bins, trash cans and the like; wherein the bag is later removed from the trash receptacle and used to carry the accumulated contents to dispose into a larger container or at a location for disposal (e.g., into a dumpster or at the curb for pickup by a trash/recycling collection service).

For years plastic bags used for bagging groceries, shopping, packaging products, recycling and more, have come with simple features and in simple shapes that open into a generally rectangular, oval, or cylindrical shape. These bags and other forms of bags are commonly re-used as a free substitute for purchased trash bags, and are most times inserted into smaller or bigger trash receptacles like wastebaskets, in order to collect garbage. Some of these bags however sometimes cannot be inserted into a trash receptacle because the bags may be too small and therefore the circumferential rim and/or top opening of the bag is unable to go around a trash receptacle. Some other bags are big enough to be inserted into a trash receptacle but these bags however after being inserted into a receptacle most times cave in or fall into the receptacle after refuse and other objects have been thrown in. This is because grocery bags, shopping bags, packaging bags, and these other forms of bags don't function properly as liners and are either too big or too small to fit properly and snugly around the rim of the trash receptacle. Due to this, a lot of consumers—instead of making a second productive use out of their plastic bags as liners for trash receptacles—end up just disposing of them too quickly.

In addition, most households deal with the issue of having to dispose of the standard size trash bag before they are fully utilized or filled with garbage because of their size. This happens in situations where certain garbage items like (rotten) foods, baby diapers, etc have been inserted into the trash bag and are therefore causing an unpleasant odor resulting in consumers having to take out the unfilled trash bag sooner than intended. This problem can be addressed by using grocery bags, shopping bags, packaging bags, and these other bags as liners because of the sometimes smaller size of these bags. This gives consumers the option of emptying out their garbage more frequently if they so choose therefore resulting in less unpleasant odor around the house. There has therefore been a need for improved grocery bags, shopping bags, packaging bags, standard trash bags, and other forms of bags adapted to be effectively used as liners for trash receptacles.

Some standard trash bags present today possess drawstrings with elastic properties located around the upper opening of the bag to help secure the bags around the garbage can and prevent the bag from caving in. These bags generally are rectangular, oval, or cylindrical in shape, still cave in, and are most times squished around the top opening of the bag. This is because most—if not all—of the length of the drawstring is located within a hem along the top opening of the bag so that when the bag is put in a trash receptacle the elastic drawstring does not have any direct contact with the trash receptacle. This thereby results in lesser grip, poor friction, and slipping of the bag into the receptacle. In addition, the circumferential rim and/or top opening of plastic bags present today have a defined width and/or diameter and cannot be increased or decreased. In regards to bags that possess drawstrings: drawstrings do not increase or expand the diameter of the bag, but just of the drawstring itself.

There is therefore a need to provide grocery bags, shopping bags, packaging bags, trash bags, and other plastic bags that grip trash receptacles effectively and have the ability for the bag's circumferential rim and/or top opening to be expanded so that smaller bags have the ability to be effectively inserted into bigger trash receptacles. Thus, an objective of the present invention is to provide bags with unique features that address this need.

### BRIEF SUMMARY OF THE INVENTION

The current invention improves bags used for various purposes including bagging groceries, trash collection, shopping, packaging products, recycling and more. The bag having an exterior surface, an interior surface, a bag body, a closed bottom end, and an open top end. The unique and distinctive features and/or shapes of the bags in current invention results in the ability for its circumferential rim and/or top opening to be expanded, and for the bag to be very secure when put in a trash receptacle. The bag in current invention preferably partially or fully biodegradable, photodegradable, compostable and/or made from recycled material.

Sheets of elastic material that contract and stretch and preferably possess frictional gripping properties, are present and used to allow the opening of the bag to be stretched and folded over the rim of a trash receptacle. The strength of the bag greater than or equal to the strength of the elastic member in order to prevent the bag from ripping during expansion of the bag open top end and/or top portion when placing the bag in a trash receptacle. The elastic member may then relax thereby providing a gripping force securing the bag to the trash receptacle.

In one embodiment, the bag may be rectangular or square in shape and possess elastic member(s)—shaped as an inverted isosceles trapezoid, isosceles trapezoid, inverted triangle, triangle, rectangle, square, circle, irregular shape, a combination of these shapes or other suitable shapes—present at certain locations on at least the top portion of the bag and/or bag body and preferably in at least the center and/or side corners. The elastic member(s) may (in some embodiments) also have a portion of it going fully or partially around the circumferential top opening of the bag. Grab handles may be present on the bag, or openings present on the bag panel(s)—permitting insertion of fingers to be used as a grab handle.

In another embodiment the top portions of the bag's sidewalls, bag panel(s), and/or bag body slant inward towards each other thereby making the top portion, the open top end, and/or circumferential rim of the bag smaller in circumference and/or diameter than the bag body and/or bottom end of the bag; and possess the same elastic member(s) and/or features as the other embodiment(s).

In another embodiment the bag may be partial or completely cylindrical or oval in shape and possess the same elastic member(s) and/or features as the other embodiment(s).

### BRIEF DESCRIPTION OF THE DRAWINGS

FIG. 1 is a front/back view of preferred embodiment of a bag.

FIG. 2 is a side view of the bag in FIG. 1.

FIG. 3 is a front/back view of another embodiment of the bag in FIG. 1.

FIG. 4 is a front/back view of another embodiment of the bag in FIG. 1.

FIG. 5 is a front/back view of another embodiment of the bag in FIG. 1.

FIG. 6 is a front/back view of another embodiment of the bag in FIG. 1.

FIG. 7 is a front/back view of another embodiment of the bag in FIG. 1.

FIG. 8 is a perspective view of a bag.

FIG. 9 is a perspective view of another embodiment of the bag in FIG. 8.

FIG. 10 is a perspective view of another embodiment of the bag in FIG. 8.

FIG. 11 is a perspective view of a bag.

FIG. 12 is a perspective view of another embodiment of the bag in FIG. 11.

FIG. 13 is a perspective view of another embodiment of the bag in FIG. 11.

FIG. 14 is a perspective view of a bag.

FIG. 15 is a perspective view of another embodiment of the bag in FIG. 14.

FIG. 16 is a perspective view of a bag.

FIG. 17 is a perspective view of another embodiment of the bag in FIG. 16.

FIG. 18 is a front/back view of a bag.

FIG. 19 is a front/back view of another embodiment of the bag in FIG. 18.

FIG. 20 is a front/back view of another embodiment of the bag in FIG. 18.

FIG. 21 is a perspective view of a bag.

FIG. 22 is a front/back view of a bag.

### DETAILED DESCRIPTION OF THE EMBODIMENTS OF THE INVENTION

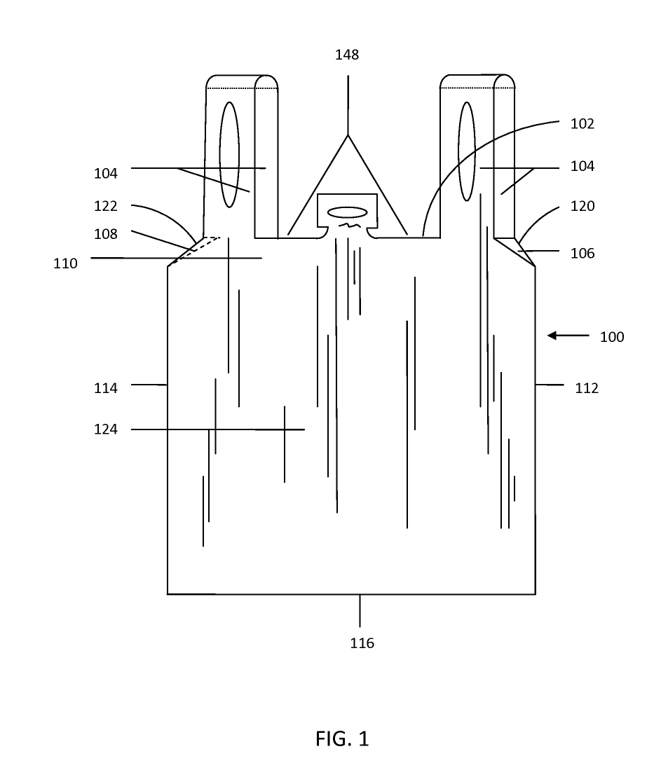

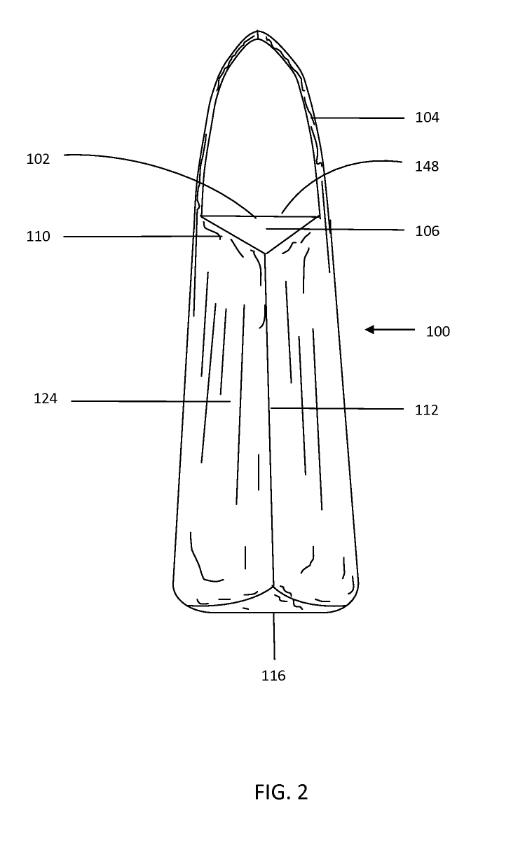

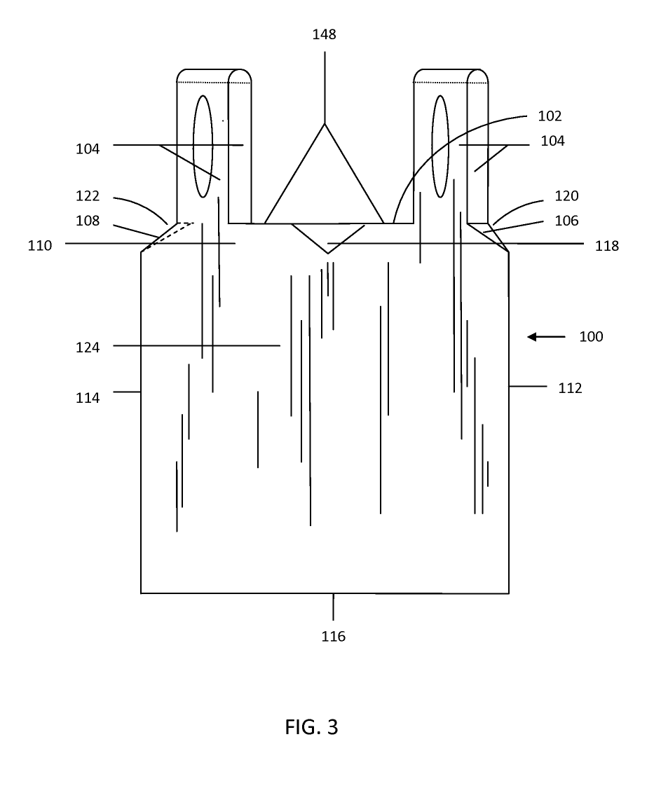

The current invention relates to improvements in disposable bags such as those currently used for various purposes including bagging groceries, trash collection, shopping, packaging products, recycling and more. These bags are commonly re-used to line trash receptacles until full and then carried to, and deposited in a larger bin or can for trash collection. The bag may be made from thin sheet material such as forms of polymer, thermoplastic, plastic, polyvinyl, vinyl, polyethylene, ethylene, rubber, a combination of, and/or other similar or suitable flexible sheet materials using conventional manufacturing means. Referring to FIG. 1 the inventive bag 100, in general having an exterior surface, an interior surface, a closed bottom end 116 and an open top end 102 with a circumferential rim 148 defining a mouth/opening. The bag having grab handles 104 present, extending from the top rim. Between the open top end 102 and closed bottom end 116, the bag 100 has a body 124 and opposed sidewalls 112, 114. Top portions 120, 122 of the sidewalls 112, 114 and/or bag body 124 slant inward towards each other thereby making a top portion 110, the open top end 102, and/or circumferential rim 148 of the bag 100 smaller in circumference and/or diameter, than the bag body 124 and/or bottom end 116 of the bag 100. Present on the sides of the top portion 110 of the bag 100 are elastic member(s) 106, 108 in their pre-stretched state prior to being inserted into a trash receptacle and preferably made from rubber, nitrile, neoprene, polypropylene, isoprene, isobutylene, polyurethane latex, polyethylene, plastic, any combinations thereof, or any other suitable elastic material of preferably non-slip nature. The characteristics of the stretchable elastic member(s) 106, 108 will enable the expansion of the bag open top end 102 (and/or circumferential rim 148) so that when the bag is placed in a trash receptacle the top portion 110 and open top end 102 of the bag can be folded over the rim of the trash receptacle. The elastic member(s) 106, 108 then relaxing thereby creating a gripping force around the rim of the receptacle to keep the bag 100 from dropping into it. Present in some embodiments on at least the exterior body of elastic member(s) 106, 108 may be certain patterns or protrusions to enhance the bag's 100 grip on a trash receptacle when placed in the trash receptacle. Referring to FIG. 2 there is shown a side view of bag 100 from FIG. 1. The inventive bag 100, in general having a closed bottom end 116 and an open top end 102 with a circumferential rim 148 defining a mouth/opening. The bag may have grab handles 104 present and extending from the top rim. Between the open top end 102 and closed bottom end 116, the bag 100 has a body 124, and opposed sidewalls 112, 114. Shown present on a side of the top portion 110 of the bag 100 is an elastic member(s) 106 in its pre stretched state. Referring to FIG. 3 there is shown another embodiment of bag 100. The bag 100, in general having an exterior surface, an interior surface, a closed bottom end 116 and an open top end 102 with a circumferential rim 148 defining a mouth/opening. The bag having grab handles 104 present extending from the top rim. Between the open top end 102 and closed bottom end 116, the bag 100 has a body 124, and opposed sidewalls 112, 114. Top portions 120, 122 of the sidewalls 112, 114 and/or bag body 124 slant inward towards each other thereby making a top portion 110, the open top end 102, and circumferential rim 148 of the bag 100 smaller in circumference and/or diameter, than the bag body 124 and/or bottom end 116 of the bag 100. Present on the sides of the top portion 110 of the bag 100 are elastic member(s) 106, 108 in their pre stretched state. Located in the center of top portion 110 is an elastic member(s) 118 in its pre stretched state.

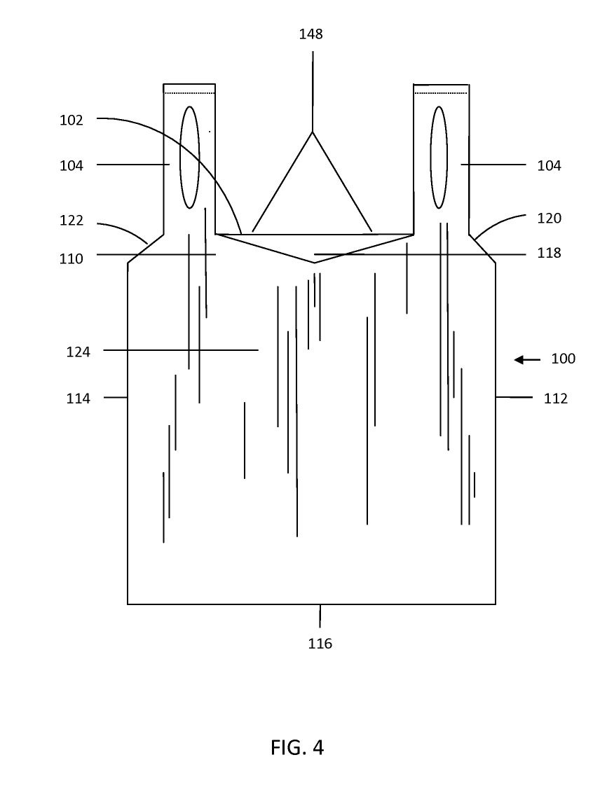

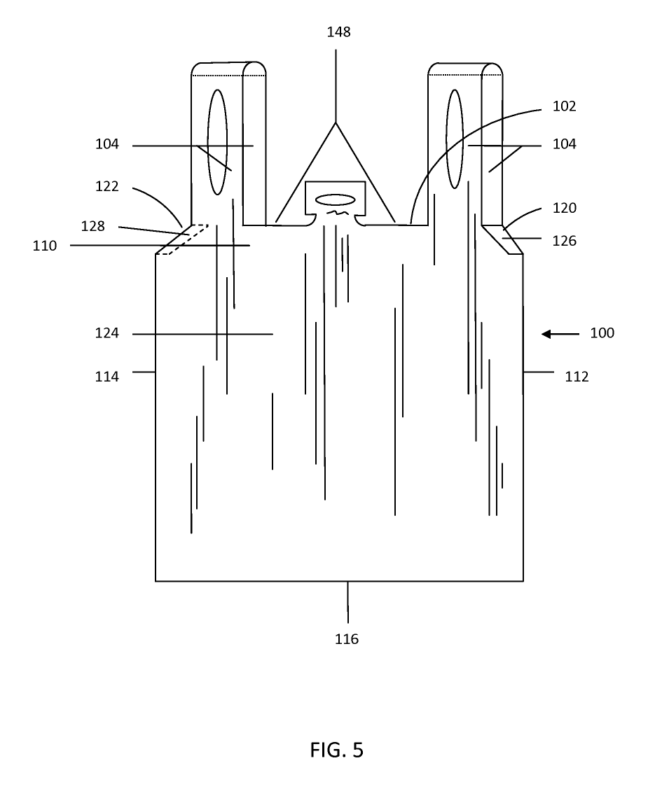

Referring to FIG. 4 there is shown another embodiment of bag 100. The bag 100, in general having an exterior surface, an interior surface, a closed bottom end 116 and an open top end 102 with a circumferential rim 148 defining a mouth/opening. The bag having grab handles 104 present extending from the top rim. Between the open top end 102 and closed bottom end 116, the bag 100 has a body 124, and opposed sidewalls 112, 114. Top portions 120, 122 of the sidewalls 112, 114 and/or bag body 124 slant inward towards each other thereby making a top portion 110, the open top end 102, and circumferential rim 148 of the bag 100 smaller in circumference and/or diameter, than the bag body 124 and/or bottom end 116 of the bag. Located in the center of top portion 110 is an elastic member(s) 118 in its pre stretched state. Referring to FIG. 5 there is shown another embodiment of bag 100. The bag 100, in general having an exterior surface, an interior surface, a closed bottom end 116 and an open top end 102 with a circumferential rim 148 defining a mouth/opening. The bag having grab handles 104 present extending from the top rim. Between the open top end 102 and closed bottom end 116, the bag 100 has a body 124, and opposed sidewalls 112, 114. Top portions 120, 122 of the sidewalls 112, 114 slant inward towards each other thereby making a top portion 110, the open top end 102, and circumferential rim 148 of the bag 100 smaller in circumference and/or diameter, than the bag body 124 and/or bottom end 116 of the bag 100. Present on the sides of the top portion 110 of the bag 100 are elastic member(s) 126, 128 in their pre stretched state.

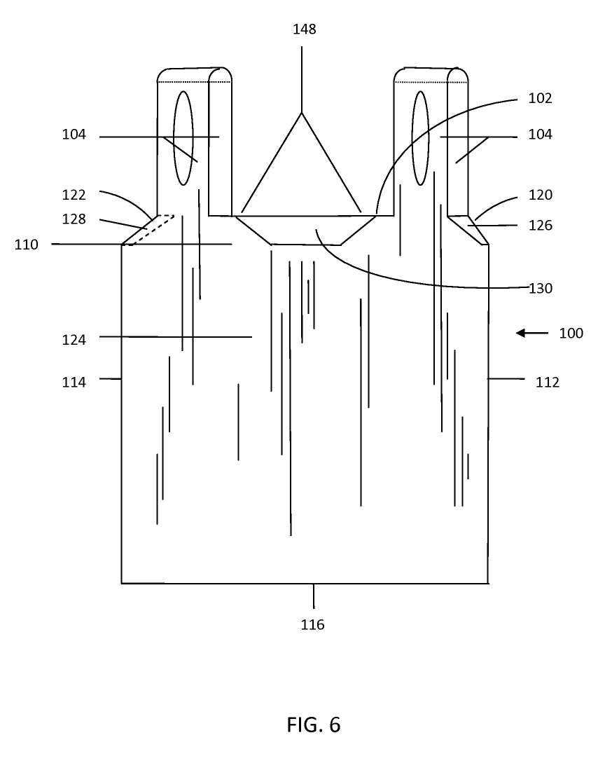

Referring to FIG. 6 there is shown another embodiment of bag 100. The bag 100, in general having an exterior surface, an interior surface, a closed bottom end 116 and an open top end 102 with a circumferential rim 148 defining a mouth/opening. The bag having grab handles 104 present extending from the top rim. Between the open top end 102 and closed bottom end 116, the bag 100 has a body 124, and opposed sidewalls 112, 114. Top portions 120, 122 of the sidewalls 112, 114 and/or bag body 124 slant inward towards each other thereby making a top portion 110, the open top end 102, and circumferential rim 148 of the bag 100 smaller in circumference and/or diameter, than the bag body 124 and/or bottom end 116 of the bag 100. Present on the sides of the top portion 110 of the bag 100 are elastic member(s) 126, 128 in their pre stretched state. Located in the center of top portion 110 is an elastic member(s) 130 in its pre stretched state.

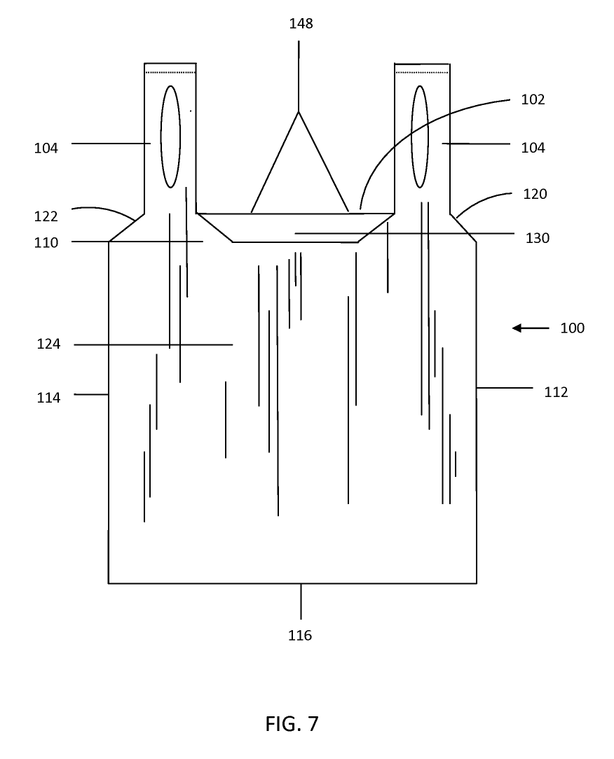

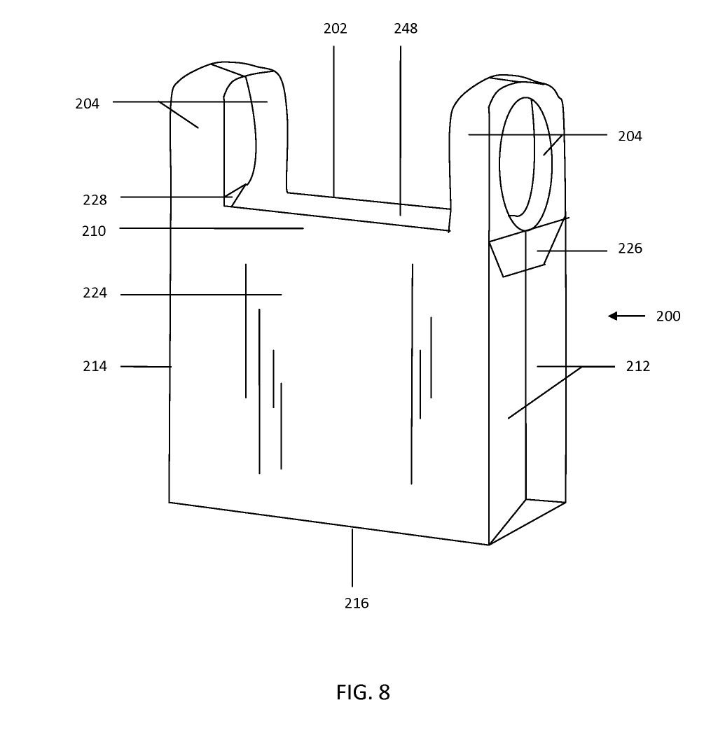

Referring to FIG. 7 there is shown another embodiment of bag 100. The bag 100, in general having an exterior surface, an interior surface, a closed bottom end 116 and an open top end 102 with a circumferential rim 148 defining a mouth/opening. The bag having grab handles 104 present extending from the top rim. Between the open top end 102 and closed bottom end 116, the bag 100 has a body 124 and opposed sidewalls 112, 114. Top portions 120, 122 of the sidewalls 112, 114 and/or bag body 124 slant inward towards each other thereby making a top portion 110, the open top end 102, and circumferential rim 148 of the bag 100 smaller in circumference and/or diameter, than the bag body 124 and/or bottom end 116 of the bag 100. Located in the center of top portion 110 is an elastic member(s) 130 in its pre stretched state. Referring to FIG. 8 a bag 200 in general having an exterior surface, an interior surface, a closed bottom end 216 and an open top end 202 with a circumferential rim 248 defining a mouth/opening. The bag having grab handles 204 present extending from the top rim. Between the open top end 202 and closed bottom end 216, the bag 200 has a body 224 and opposed sidewalls 212, 214. Present on the sides of the top portion 210 of the bag 200 are elastic member(s) 226, 228 in their pre stretched state. The characteristics of the elastic member(s) 226, 228 will enable the expansion of the bag open top end 202 and circumferential rim 248 so that when the bag 200 is placed in a trash receptacle the top portion 210 and open top end 202 of the bag can be folded over the rim of the trash receptacle. The elastic member(s) 226, 228 then relaxing thereby creating a gripping force around the rim of the receptacle to keep the bag 200 from dropping into it. Present on at least the exterior body of elastic member(s) 226, 228 may be certain patterns or protrusions to enhance the bag's 200 grip on a trash receptacle when placed in the trash receptacle.

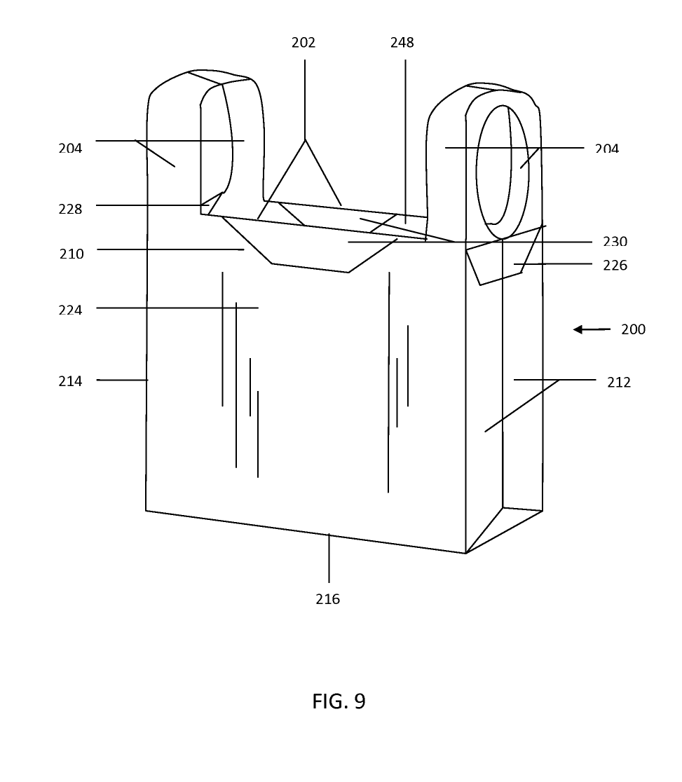

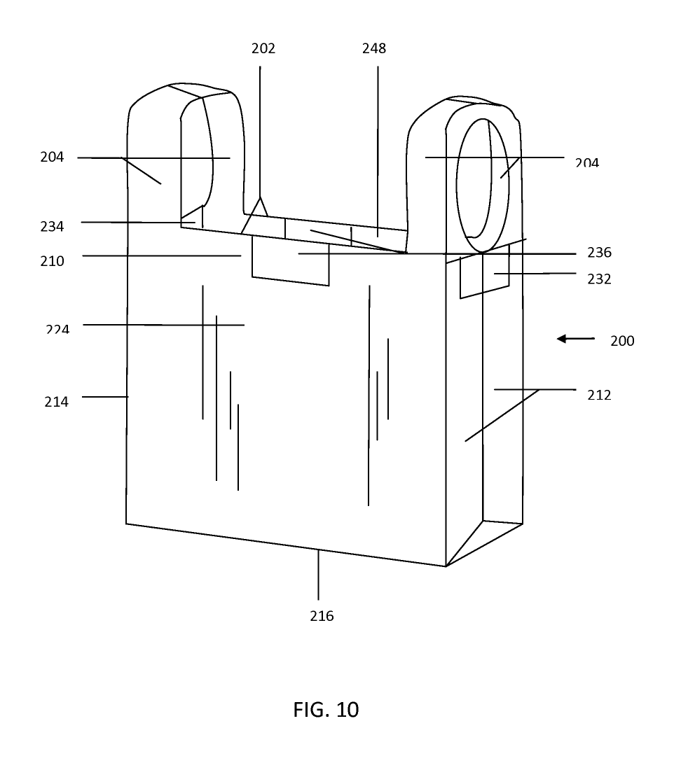

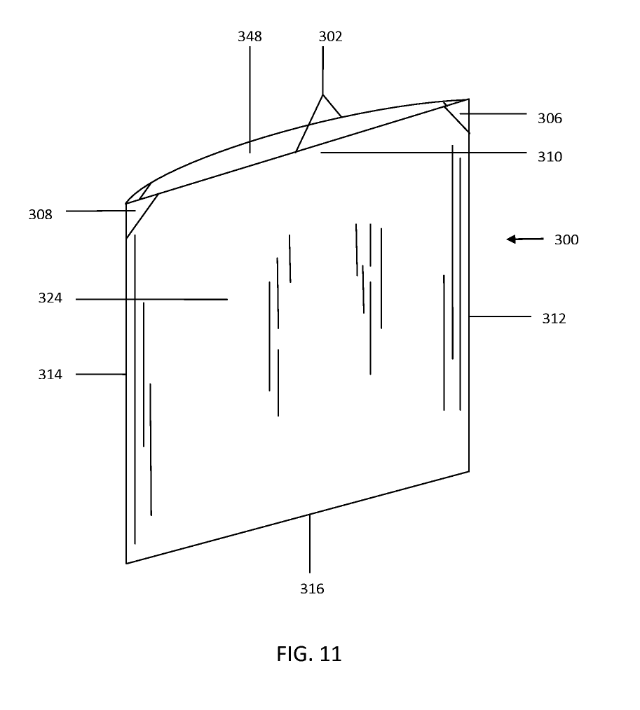

Referring to FIG. 9 there is shown another embodiment of bag 200. The bag 200, in general having an exterior surface, an interior surface, a closed bottom end 216 and an open top end 202 with a circumferential rim 248 defining a mouth/opening. The bag having grab handles 204 present extending from the top rim. Between the open top end 202 and closed bottom end 216, the bag 200 has a body 224 and opposed sidewalls 212, 214. Present on the sides of the top portion 210 of the bag 200 are elastic member(s) 226, 228 in their pre stretched state. Located in the center of top portion 210 is elastic member(s) 230 in its pre stretched state. Referring to FIG. 10 there is shown another embodiment of bag 200. The bag 200, in general having an exterior surface, an interior surface, a closed bottom end 216 and an open top end 202 with a circumferential rim 248 defining a mouth/opening. The bag having grab handles 204 present extending from the top rim. Between the open top end 202 and closed bottom end 216, the bag 200 has a body 224 and opposed sidewalls 212, 214. Present on the sides of the top portion 210 of the bag 200 are elastic member(s) 232, 234 in their pre stretched state. Located in the center of top portion 210 is elastic member(s) 236 in its pre stretched state. Referring to FIG. 11 a bag 300 in general having an exterior surface, an interior surface, a closed bottom end 316 and an open top end 302 with a circumferential rim 348 defining a mouth/opening. Between the open top end 302 and closed bottom end 316, the bag 300 has a body 324, and opposed sidewalls 312, 314. Present on the sides of the top portion 310 of the bag 300 are elastic member(s) 306, 308 in their pre stretched state. The characteristics of the stretchable elastic member(s) 306, 308 will enable the expansion of the bag open top end 302 and circumferential rim 348 so that when the bag is placed in a trash receptacle the top portion 310 and open top end 302 of the bag can be folded over the rim of the trash receptacle. The elastic member(s) 306, 308 then relaxing thereby creating a gripping force around the rim of the receptacle to keep the bag 300 from dropping into it. Present on at least the exterior body of elastic member(s) 306, 308 may be certain patterns or protrusions to enhance the bag's 300 grip on a trash receptacle when placed in the trash receptacle.

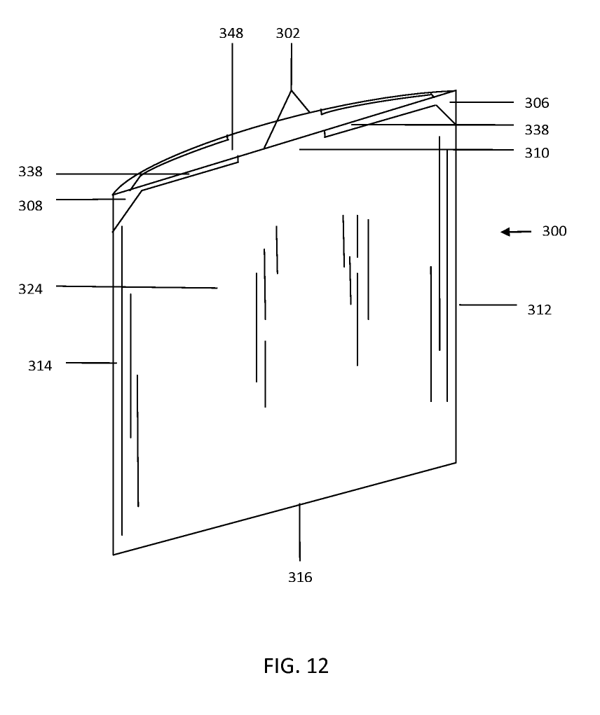

Referring to FIG. 12 there is shown another embodiment of bag 300. The bag 300 in general having an exterior surface, an interior surface, a closed bottom end 316 and an open top end 302 with a circumferential rim 348 defining a mouth/opening. Between the open top end 302 and closed bottom end 316, the bag 300 has a body 324, and opposed sidewalls 312, 314. Present on the sides of the top portion 310 of the bag 300 are elastic member(s) 306, 308 possessing a portion 338 going partially or fully along circumferential rim 348 and/or open top end 302.

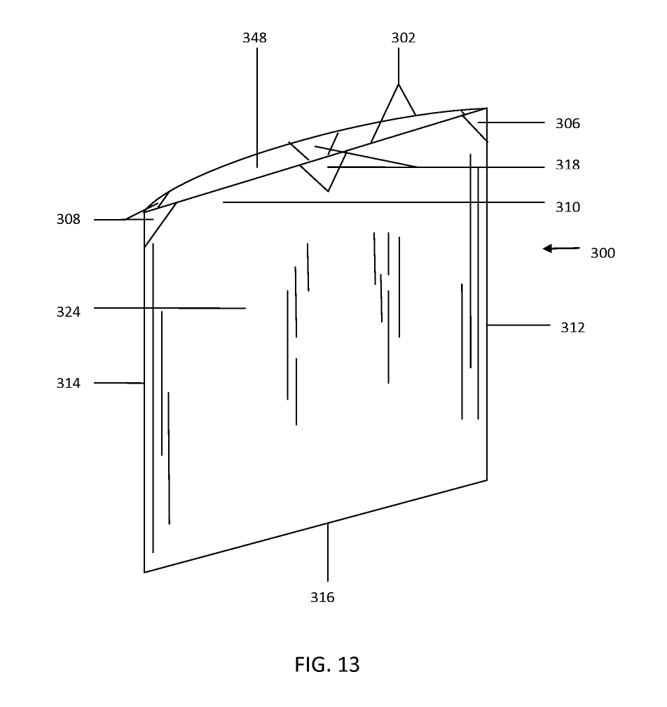

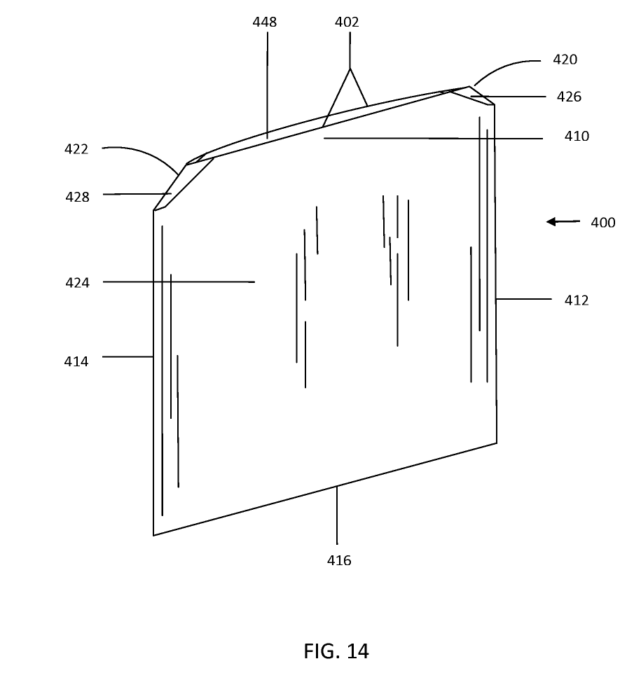

Referring to FIG. 13 there is shown another embodiment of bag 300. The bag 300 in general having an exterior surface, an interior surface, a closed bottom end 316 and an open top end 302 with a circumferential rim 348 defining a mouth/opening. Between the open top end 302 and closed bottom end 316, the bag 300 has a body 324 and opposed sidewalls 312, 314. Present on the sides of the top portion 310 of the bag 300 are elastic member(s) 306, 308 in their pre stretched state. Located in the center of top portion 310 is elastic member(s) 318 in its pre stretched state. Referring to FIG. 14 a bag 400 in general having an exterior surface, an interior surface, a closed bottom end 416 and an open top end 402 with a circumferential rim 448 defining a mouth/opening. Between the open top end 402 and closed bottom end 416, the bag 400 has a body 424, and opposed sidewalls 412, 414. Top portions 420, 422 of the sidewalls 412, 414 and/or bag body 424 slant inward towards each other thereby making a top portion 410, the open top end 402, and circumferential rim 448 of the bag 400 smaller in circumference and/or diameter, than the bag body 424 and/or bottom end 416 of the bag. Present on the sides of the top portion 410 of the bag 400 are elastic member(s) 426, 428 in their pre stretched state.

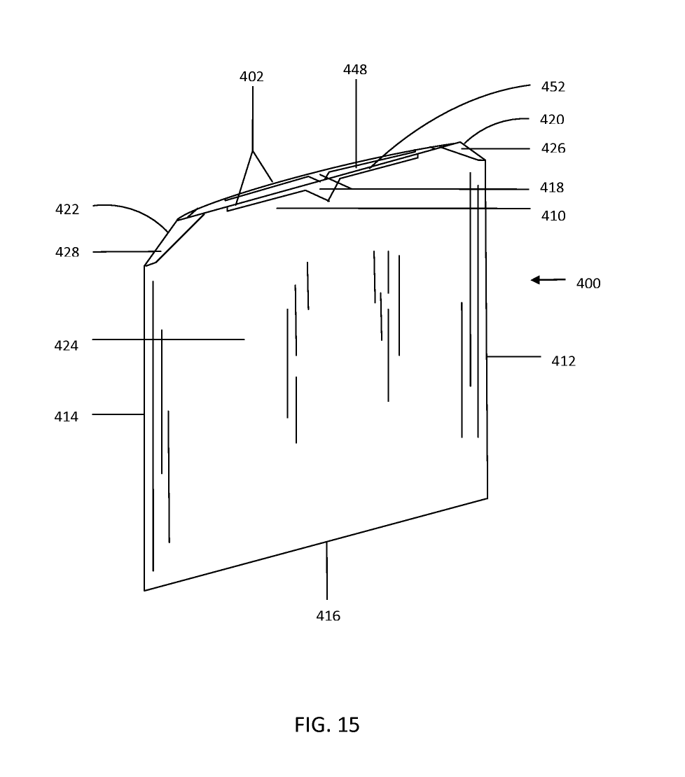

Referring to FIG. 15 there is shown another embodiment of bag 400. Bag 400 in general having an exterior surface, an interior surface, a closed bottom end 416 and an open top end 402 with a circumferential rim 448 defining a mouth/opening. Between the open top end 402 and closed bottom end 416, the bag 400 has a body 424 and opposed sidewalls 412, 414. Top portions 420, 422 of the sidewalls 412, 414 and/or bag body 424 slant inward towards each other thereby making a top portion 410, the open top end 402, and circumferential rim 448 of the bag 400 smaller in circumference and/or diameter, than the bag body 424 and/or bottom end 416 of the bag. Present on the sides of the top portion 410 of the bag 400 are elastic member(s) 426, 428 in their pre stretched state. Located in the center of top portion 410 is an elastic member(s) 418 possessing a portion 452 going partially or fully along circumferential rim 448 and/or open top end 402 of bag 400.

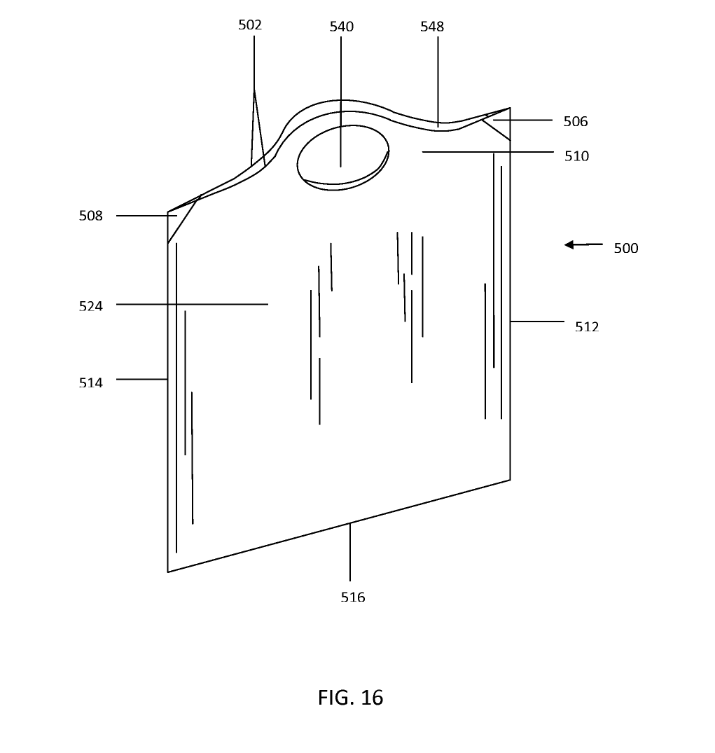

Referring to FIG. 16 a bag 500 in general having an exterior surface, an interior surface, a closed bottom end 516 and an open top end 502 with a circumferential rim 548 defining a mouth/opening. Between the open top end 502 and closed bottom end 516, the bag 500 has a body 524, and opposed sidewalls 512, 514. Present on the top portion of bag 500 is opening(s) 540 to permit insertion of fingers to be used as a grab handle. Present on the sides of the top portion 510 of the bag 500 are elastic member(s) 506, 508 in their pre stretched state. The characteristics of the stretchable elastic member(s) 506, 508 will enable the expansion of the bag open top end 502 and circumferential rim 548 so that when the bag is placed in a trash receptacle the top portion 510 and open top end 502 of the bag can be folded over the rim of the trash receptacle. The elastic member(s) 506, 508 then relaxing thereby creating a gripping force around the rim of the receptacle to keep the bag 500 from dropping into it. Present on at least the exterior body of elastic member(s) 506, 508 may be certain patterns or protrusions to enhance the bag's 500 grip on a trash receptacle when placed in the trash receptacle.

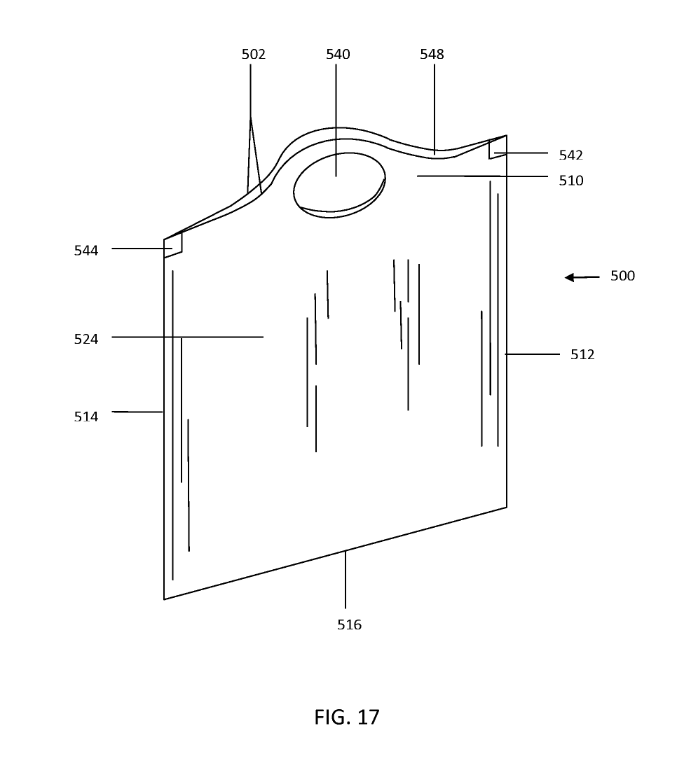

Referring to FIG. 17 there is shown another embodiment of bag 500. Bag 500 in general having an exterior surface, an interior surface, a closed bottom end 516 and an open top end 502 with a circumferential rim 548 defining a mouth/opening. Between the open top end 502 and closed bottom end 516, the bag 500 has a body 524 and opposed sidewalls 512, 514. Present on the top portion of bag 500 are openings 540 to permit insertion of fingers to be used as a grab handle. Present on the sides of the top portion 510 of the bag 500 are elastic member(s) 542, 544 in their pre stretched state.

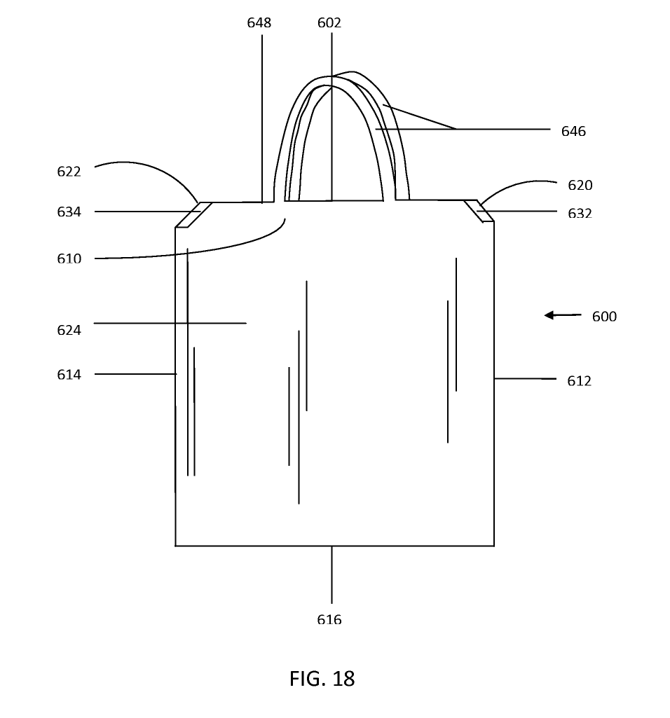

Referring to FIG. 18 a bag 600 in general having an exterior surface, an interior surface, a closed bottom end 616 and an open top end 602 with a circumferential rim 648 defining a mouth/opening. The bag having grab handles 646 present extending from the top rim. Between the open top end 602 and closed bottom end 616, the bag 600 has a body 624, and opposed sidewalls 612, 614. Top portions 620, 622 of the sidewalls 612, 614 and/or bag body 624 slant inward towards each other thereby making a top portion 610, the open top end 602, and circumferential rim 648 of the bag 600 smaller in circumference and/or diameter, than the bag body 624 and/or bottom end 616 of the bag. Present on the sides of the top portion 610 of the bag 600 are elastic member(s) 632, 634 in their pre stretched state.

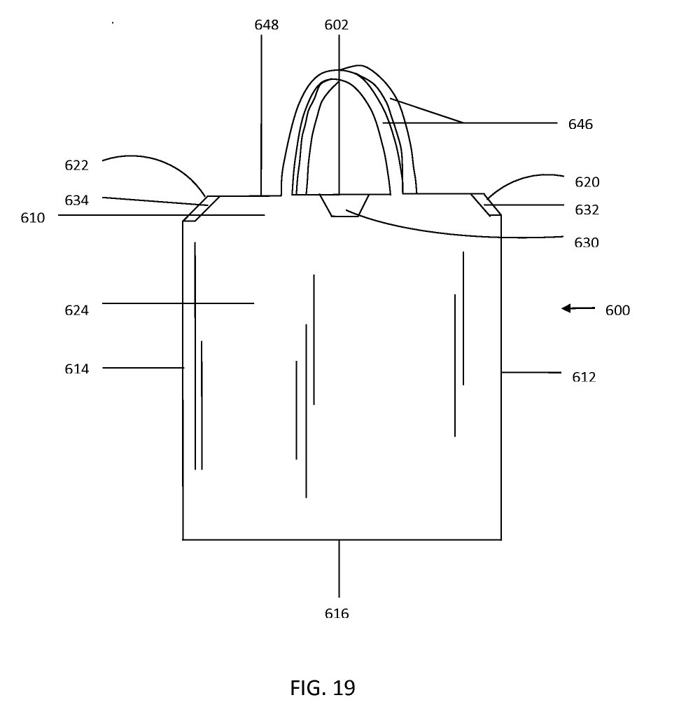

Referring to FIG. 19 there is shown another embodiment of bag 600. Bag 600 in general having an exterior surface, an interior surface, a closed bottom end 616 and an open top end 602 with a circumferential rim 648 defining a mouth/opening. The bag having grab handles 646 present extending from the top rim. Between the open top end 602 and closed bottom end 616, the bag 600 has a body 624, and opposed sidewalls 612, 614. Top portions 620, 622 of the sidewalls 612, 614 and/or bag body 624 slant inward towards each other thereby making a top portion 610, the open top end 602, and circumferential rim 648 of the bag 600 smaller in circumference and/or diameter, than the bag body 624 and/or bottom end 616 of the bag. Present on the sides of the top portion 610 of the bag 600 are elastic member(s) 632, 634 in their pre stretched state. Located in the center of top portion 610 is elastic member(s) 630 in its pre stretched state.

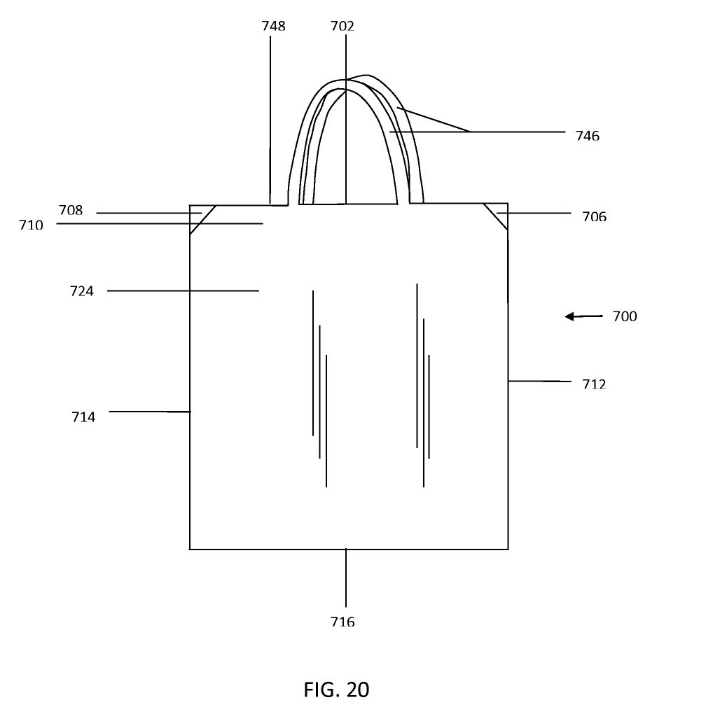

Referring to FIG. 20 a bag 700 in general having an exterior surface, an interior surface, a closed bottom end 716 and an open top end 702 with a circumferential rim 748 defining a mouth/opening. The bag having grab handles 746 present extending from the top rim. Between the open top end 702 and closed bottom end 716, the bag 700 has a body 724 and opposed sidewalls 712, 714. Present on the sides of the top portion 710 of the bag 700 are elastic member(s) 706, 708 in their pre stretched state. The characteristics of the stretchable elastic member(s) 706, 708 will enable the expansion of the bag open top end 702 and circumferential rim 748 so that when the bag is placed in a trash receptacle the top portion 710 and open top end 702 of the bag can be folded over the rim of the trash receptacle. The elastic member(s) 706, 708 then relaxing thereby creating a gripping force around the rim of the receptacle to keep the bag 700 from dropping into it. Present on at least the exterior body of elastic member(s) 706, 708 may be certain patterns or protrusions to enhance the bag's 700 grip on a trash receptacle when placed in the trash receptacle.

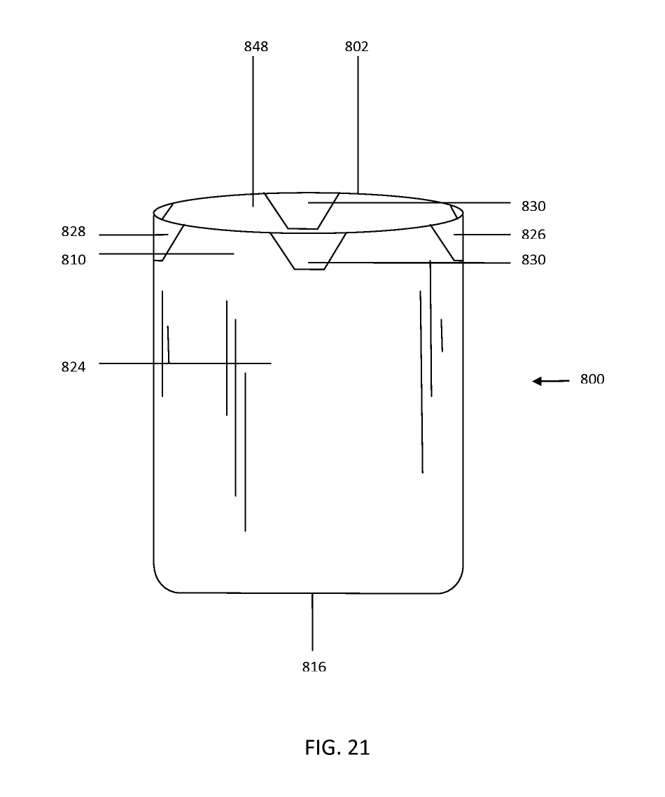

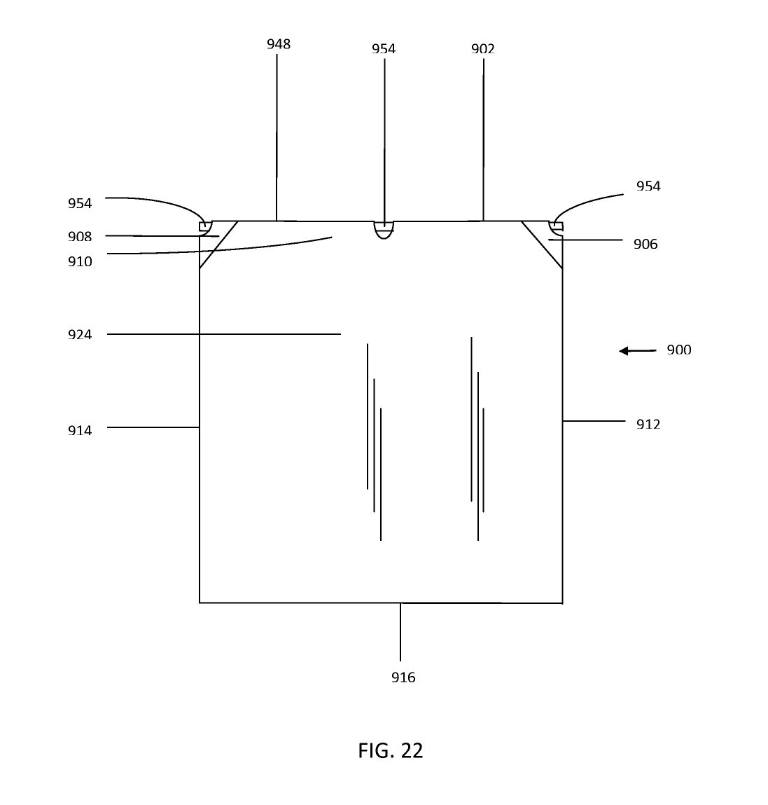

Referring to FIG. 21 a bag 800 in general having an exterior surface, an interior surface, a closed bottom end 816 and an open top end 802 with a circumferential rim 848 defining a mouth/opening. Between the open top end 802 and closed bottom end 816, the bag 800 has a body 824. Present along the top portion 810 of the bag body 824 are elastic member(s) 826, 828, 830 in their pre stretched state. The characteristics of the stretchable elastic member(s) 826, 828, 830 will enable the expansion of the bag open top end 802 and circumferential rim 848 so that when the bag is placed in a trash receptacle the top portion 810 and open top end 802 of the bag can be folded over the rim of the trash receptacle. The elastic member(s) 826, 828, 830 then relaxing thereby creating a gripping force around the rim of the receptacle to keep the bag 800 from dropping into it. Present on at least the exterior body of elastic member(s) 826, 828, 830 may be certain patterns or protrusions to enhance the bag's 800 grip on a trash receptacle when placed in the trash receptacle. Referring to FIG. 22 a bag 900 in general having an exterior surface, an interior surface, a closed bottom end 916 and an open top end 902 with a circumferential rim 948 defining a mouth/opening. Between the open top end 902 and closed bottom end 916, the bag 900 has a body 924, and opposed sidewalls 912, 914. Present on the sides of the top portion 910 of the bag 900 are elastic member(s) 906, 908 in their pre stretched state. The characteristics of the stretchable elastic member(s) 906, 908 will enable the expansion of the bag open top end 902 and circumferential rim 948 so that when the bag is placed in a trash receptacle the top portion 910 and open top end 902 of the bag can be folded over the rim of the trash receptacle. The elastic member(s) 906, 908 then relaxing thereby creating a gripping force around the rim of the receptacle to keep the bag 900 from dropping into it. Located along circumferential rim 948 and/or open top end 902 of bag 900 is a drawstring/drawrope 954.

Although the invention has been illustrated and described in the drawings and foregoing description, the same is to be considered as illustrative and not restrictive in character—it being understood that only preferred embodiments have been shown and described, and that all changes and modifications that come within the spirit of the invention as claimed are desired to be protected. Undoubtedly, many other “modifications” and “variations” on the “themes” set forth hereinabove will occur to one having ordinary skill in the art to which the present invention most nearly pertains, and such variations are intended to be within the scope of the invention, as disclosed herein. The bag features in the diagrams may not be restricted to only one side of the bag. The size, shape, length, width, location and materials of the various components may vary without departing from the spirit of the invention. Many of the embodiments listed may be combined with each other to form additional embodiments of the bag. The use of certain singular and plural terms like “an”, “a”, “it”, “their”, “is”, “are” and similar terms while describing the present invention are to be interpreted to cover both singular and plural. The use of the term “and” while describing the present invention is to be interpreted to also cover the term “or”. Furthermore, any combination of the described elements in all variations possible thereof is covered by the invention unless otherwise indicated. The terms “possessing”, “having”, “containing,” “including,” and other similar terms are to be interpreted as open-ended terms (i.e., meaning “including, but not limited to,”) unless otherwise noted.

1. A bag for receiving refuse comprising; a bag body, an inside surface, an outside surface, a closed bottom end, and an open top end with a circumferential rim defining a top portion of the bag wherein at least a portion thereof is a stretchable elastic member that stretches to allow expansion of the bag open top end; and wherein bag material in the top portion around the elastic member has strength greater than or equal to strength of the elastic member in order to prevent the bag from ripping during expansion of the bag open top end and top portion when placing the bag in a trash receptacle; whereupon the stretchable elastic member may relax, thereby providing a gripping force securing the bag to the trash receptacle.

2. The bag of claim 1, wherein, the elastic member is tacky or non-slip with frictional gripping properties.

3. The bag of claim 1, wherein the elastic member in a pre-stretched state is rectangular in shape.

4. (canceled)

5. The bag of claim 1, wherein the elastic member in a pre-stretched state is an inverted trapezoidal or triangular shape.

6. The bag of claim 1, wherein the elastic members in a pre-stretched state is circumferentially wider at a top rim than at a bottom end of the elastic member.

7. The bag of claim 1, wherein two elastic members are disposed approximately 180 degrees apart.

8. The bag of claim 1, wherein patterns or protrusions are present on an outside surface of the elastic member to enhance the bag's grip when placed in the trash receptacle.

9. (canceled)

10. The bag of claim 1, wherein grab handles are present extending from the circumferential rim of the bag.

11. The bag of claim 1, wherein openings are present in the bag to permit insertion of fingers to be used as a grab handle.

12. (canceled)

13-20. (canceled)

21. The bag of claim 1, wherein at least a portion of the top portion of the bag slants inward, thereby making the open top end of the bag smaller in circumference or diameter than the bag body while the elastic member is in a pre-stretched state.
